(19) United States
(12) Patent Application Publication
(10) Pub. No.: US 2019/0047557 A1
(43) Pub. Date: Feb. 14, 2019

(54) CONTROL APPARATUS AND METHOD OF FORWARD COLLISION-AVOIDANCE SYSTEM

(71) Applicant: HYUNDAI MOBIS Co., Ltd., Seoul (KR)

(72) Inventors: Jae Yoon KIM, Yongin-si (KR); Seung Wuk MOON, Yongin-si (KR)

(21) Appl. No.: 16/100,567

(22) Filed: Aug. 10, 2018

(30) Foreign Application Priority Data
Aug. 11, 2017 (KR) 10-2017-0102028

(51) Int. Cl. B60W 30/09; B60W 40/068; B60W 40/13; B60W 40/076

(52) U.S. Cl. CPC B60W 30/09; B60W 40/068; B60W 2720/106; B60W 40/076; B60W 40/13

(57) ABSTRACT

A control apparatus of a forward collision-avoidance (“FCA”) system including: a vehicle weight detection unit configured to detect the weight of a vehicle; a friction coefficient calculation unit configured to calculate the friction coefficient of a driving road; a gradient calculation unit configured to calculate an acceleration correction value for a road slope as slope information of the road by reflecting actual acceleration information sensed through a wheel speed sensor into information sensed through an acceleration sensor; and a control unit configured to calculate a compensation value by reflecting at least one of the slope of the road, the weight of the vehicle, and the friction coefficient of the road, and compensate an FCA command.

### CROSS-REFERENCE TO RELATED APPLICATION

This application claims priority from and the benefit of Korean Patent Application No. 10-2017-0102028, filed on Aug. 11, 2017, which is hereby incorporated by reference for all purposes as if set forth herein.

### BACKGROUND

### Field

Exemplary embodiments relates to a control apparatus and method of a forward collision-avoidance assist (FCA) system, and more particularly, to a control apparatus and method of an FCA system, which can avoid a collision or reduce a collision speed by adjusting an AEB (Autonomous Emergency Braking) control amount and a braking point in consideration of the condition of a driving road and the weight of a vehicle, thereby preventing an accident or minimizing accident damage.

### Discussion of the Background

The FCA system for a vehicle recognizes a vehicle ahead of an ego vehicle using a sensor. When the ego vehicle is expected to collide with the vehicle, the FCA system warns a driver, and automatically operates the brake to avoid the collision or reduce damage in case of an emergency. The FCA system is also referred to as an AEB (Autonomous Emergency Brake).

The sensor may include a radar or camera, and an FCA system to which two sensors are applied at the same time can sense even a pedestrian, thereby preventing an injury accident.

Ideally, the FCA system must prevent a collision by stably braking the vehicle under any driving situation. In actual driving situations, however, the FCA system may encounter driving roads with various conditions (for example, slope and friction coefficient), while applied to vehicles with various weights. Therefore, when braking control is uniformly performed in all driving situations without considering the road conditions and the vehicle weights, the effect of the FCA system may be degraded.

The related art of the prevent invention is disclosed in Korean Patent Publication No. 10-2016-0033513 published on Mar. 28, 2016 and entitled “Autonomous emergency braking system and method for vehicle”.

The above information disclosed in this Background section is only for enhancement of understanding of the background of the invention and, therefore, it may contain information that does not constitute prior art.

### SUMMARY

Exemplary Embodiments of the present invention are directed to a control apparatus and method of an FCA system, which can avoid a collision or reduce a collision speed by adjusting an AEB control amount and a braking point in consideration of the condition of a driving road and the weight of a vehicle, thereby preventing an accident or minimizing accident damage.

In one embodiment, a control apparatus of an FCA system may include: a vehicle weight detection unit configured to detect the weight of a vehicle; a friction coefficient calculation unit configured to calculate the friction coefficient of a driving road; a gradient calculation unit configured to calculate an acceleration correction value for a road slope as slope information of the road by reflecting actual acceleration information sensed through a wheel speed sensor into information sensed through an acceleration sensor; and a control unit configured to calculate a compensation value by reflecting one or more of the slope of the road, the weight of the vehicle and the friction coefficient of the road, and compensate an FCA command.

The gradient calculation unit may calculate a gradient based on a difference between an acceleration value sensed by the acceleration sensor and an actual acceleration value of the vehicle, as an acceleration difference caused by the slope of the road.

The control unit may output the compensated FCA command to a brake operation unit, and control a target braking control amount and a target braking point.

The control unit may compensate the FCA command using the compensation value obtained by reflecting one or more of the slope of the road, the weight of the vehicle and the friction coefficient of the road. The compensated FCA command may be calculated by adding the compensation value (α(gsinθ)+β(M)+γ(μMg)) to the existing FCA command, where α, β and γ represent weights for the respective parameters.

The control unit may output the FCA command obtained by increasing the target braking control amount based on a target braking control amount on a flat road, when the road slope is a downhill slope, and output the FCA command obtained by decreasing the target braking control amount when the road slope is an uphill slope. The control unit may output the FCA command obtained by advancing the target braking point based on a target braking point on the flat road, when the road slope is a downhill slope, and output the FCA command obtained by delaying the target braking point when the road slope is an uphill slope.

The control unit may output the FCA command obtained by decreasing the target braking control amount based on a target braking control amount at a general friction coefficient set to a reference friction coefficient, as the road friction coefficient becomes smaller than the general friction coefficient. The control unit may output the FCA command obtained by advancing the target braking point based on a target braking point at the general friction coefficient, as the road friction coefficient becomes smaller than the general friction coefficient.

The control unit may output the FCA command obtained by increasing the target braking control amount based on a target braking control amount at a general weight set to a reference weight, as the vehicle weight is increased. The control unit may output the FCA command obtained by advancing the target braking point based on a target braking point at the general weight, as the vehicle weight is increased.

In another embodiment, a control method of an FCA system may include: detecting the weight of a vehicle through a vehicle weight detection unit; calculating the friction coefficient of a driving road through a friction coefficient calculation unit; calculating, by a gradient calculation unit, an acceleration correction value for a road slope as slope information of the road by reflecting actual acceleration information sensed through a wheel speed sensor into information sensed through an acceleration sensor; and calculating, by a control unit, a compensation value by reflecting one or more of the slope of the road surface, the weight of the vehicle and the friction coefficient of the road, and compensating an FCA command.

In order to calculate the slope information of the road, the gradient calculation unit may calculate a gradient based on a difference between the acceleration value sensed by an acceleration sensor and the actual acceleration value of the vehicle, as an acceleration difference caused by the slope of the road.

After compensating the FCA command, the control unit may output the compensated FCA command to a brake operation unit, and control a target braking control amount and a target braking point.

In the compensating of the FCA command, the control unit may compensate the FCA command using a compensation value obtained by reflecting one or more of the slope of the road, the weight of the vehicle and the friction coefficient of the road. The compensated FCA command may be calculated by adding the compensation value (α(gsinθ)+β(M)+γ(μMg)) to the existing FCA command, where α, β and γ represent weights for the respective parameters.

The control unit may output the FCA command obtained by increasing the target braking control amount based on a target braking control amount on a flat road, when the road slope is a downhill slope, and output the FCA command obtained by decreasing the target braking control amount when the road slope is an uphill slope. The control unit may output the FCA command obtained by advancing the target braking point based on a target braking point on the flat road, when the road slope is a downhill slope, and output the FCA command obtained by delaying the target braking point when the road slope is an uphill slope.

The control unit may output the FCA command obtained by decreasing the target braking control amount based on a target braking control amount at a general friction coefficient set to a reference friction coefficient, as the road friction coefficient becomes smaller than the general friction coefficient. The control unit may output the FCA command obtained by advancing the target braking point based on a target braking point at the general friction coefficient, as the road friction coefficient becomes smaller than the general friction coefficient.

The control unit may output the FCA command obtained by increasing the target braking control amount based on a target braking control amount at a general weight set to a reference weight, as the vehicle weight is increased. The control unit may output the FCA command obtained by advancing the target braking point based on a target braking point at the general weight, as the vehicle weight is increased.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a schematic configuration of a control apparatus of an FCA system in accordance with an embodiment of the present invention.

FIG. 2 illustrates an operation of a gradient calculation unit in FIG. 1.

FIG. 3 illustrates a process in which a control unit calculates a compensation amount of an FCA command in FIG. 1.

FIG. 4A, FIG. 4B, FIG. 5A, FIG. 5B, FIG. 6A, and FIG. 6B illustrate a difference between an existing FCA command and a compensated FCA command into which the condition of a driving road and the weight of a vehicle are reflected.

FIG. 7 is a flowchart illustrating a control method of an FCA system in accordance with an embodiment of the present invention.

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

Hereafter, a control apparatus and method of an FCA system in accordance with an embodiment of the present invention will be described in detail with reference to the accompanying drawings.

It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators.

Therefore, definition of the terms should be made according to the overall disclosures set forth herein.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

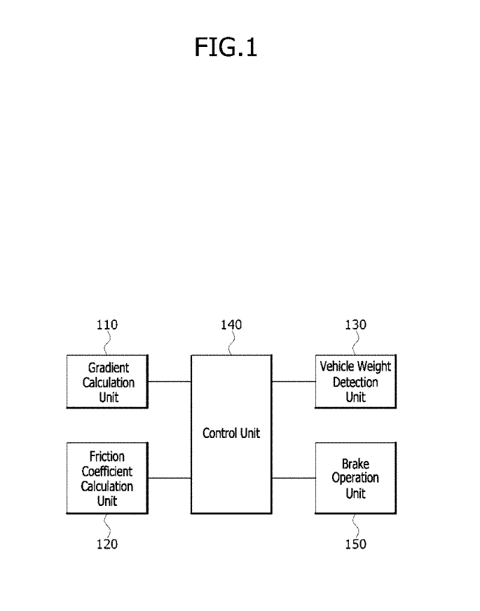

FIG. 1 illustrates a schematic configuration of a control apparatus of an FCA system in accordance with an embodiment of the present invention.

As illustrated in FIG. 1, the control apparatus of the FCA system in accordance with the present embodiment may include a gradient calculation unit 110, a friction coefficient calculation unit 120, a vehicle weight detection unit 130, a control unit 140 and a brake operation unit 150.

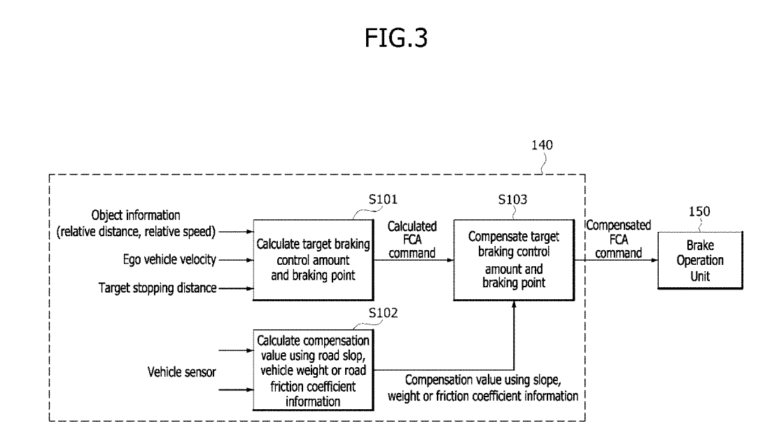

The gradient calculation unit 110 may calculate or estimate a corrected gradient (i.e. road slope) by reflecting information (for example, actual acceleration information of a vehicle) detected through a second vehicle sensor, for example, a wheel speed sensor into information (for example, acceleration information) detected through a first vehicle sensor, for example, an acceleration sensor (refer to FIG. 3).

The value of the first vehicle sensor may be provided through CAN (Controller Area Network) communication, and the actual acceleration information may be obtained by differentiating the value of the second vehicle sensor.

Therefore, the gradient calculation unit 110 can calculate or estimate the gradient according to an acceleration difference caused by a road slope, i.e. a difference between the acceleration value sensed through the acceleration sensor and the actual acceleration value of the vehicle.

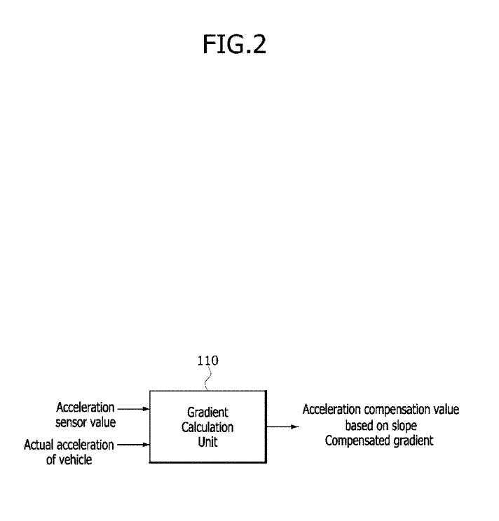

FIG. 2 illustrates the operation of the gradient calculation unit in FIG. 1. As illustrated in FIG. 2, the gradient calculation unit 110 may calculate or estimate an acceleration correction value (=g (acceleration of gravity) * sin(slope angle)) according to the road slope, and output the corrected gradient (i.e. road slope) to the control unit 140 (refer to FIG. 3).

The friction coefficient calculation unit 120 may calculate or estimate the friction coefficient μMg of the road. For example, the friction coefficient calculation unit 120 may calculate or estimate the friction coefficient of the road using a wheel speed sensor value of the vehicle and an engine torque value provided from an ECU (Engine Control Unit). Since the friction coefficient of the road surface can be calculated or estimated through various publicly known methods, the detailed descriptions of the process are omitted herein.

The vehicle weight detection unit 130 may detect or measure the weight of the vehicle using a sensor mounted in the vehicle, for example, a weight sensor. The weight of the vehicle may indicate the total weight of the vehicle including passengers and freight load on the vehicle.

The control unit 140 may calculate a compensation amount by reflecting one or more of the road slope, the vehicle weight and the friction coefficient of the road, which are calculated or detected through the gradient calculation unit 110, the friction coefficient calculation unit 120 and the vehicle weight detection unit 130, and compensate an FCA command (i.e. target braking control amount and braking point) (refer to FIG. 3).

The control unit 140 may output the compensated FCA command (i.e. the command for the target braking control amount and the braking point) to the brake operation unit 150.

The operation of the control unit 140 will be described in more detail with reference to FIG. 3.

FIG. 3 illustrates the process in which the control unit calculates the compensation amount of the FCA command in FIG. 1. As illustrated in FIG. 3, the control unit 140 may calculate the FCA command (i.e. the target braking control amount and the braking point) based on object information (i.e. relative distance and relative velocity), ego vehicle velocity and a preset target stopping distance, at step S101.

The control unit 140 may calculate or estimate a compensation value for compensating the FCA command, based on the sensing information sensed through the plurality of sensors mounted in the vehicle (for example, the acceleration sensor, the wheel speed sensor, the weight sensor and the like) and the road slope, the vehicle weight or the road friction coefficient information, at step S102.

The control unit 140 may compensate the FCA command (i.e. the command for the target braking control amount and the braking point) by reflecting the road slope (g*sinθ), the vehicle weight M or the road friction coefficient μMg calculated or estimated at step S102 into the FCA command calculated at step S101, at step S103.

For example, the control unit 140 may calculate the FAC command cmd_new of step S103 by adding the value into which the road grad gsineθ, the vehicle weight M or the road friction coefficient μMg are reflected (α(gsinθ)+β(M)+γ(μMg)) to the existing FCA command cmd old calculated at step S101. Here, α, β and γ represent weights for the respective parameters (for example, the road slope, the vehicle weight and the road friction coefficient), θ represents the road angle, M represents the vehicle weight, μ represents the road friction coefficient, and g represents the acceleration of gravity.

The control unit 140 may output the compensated FCA command (cmd_new=cmd_old+α(gsinθ)+β(M)+γ(μMg)) to the brake operation unit 150.

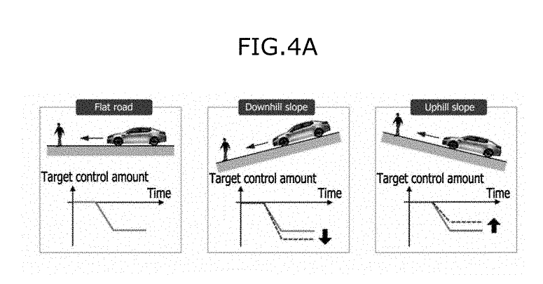

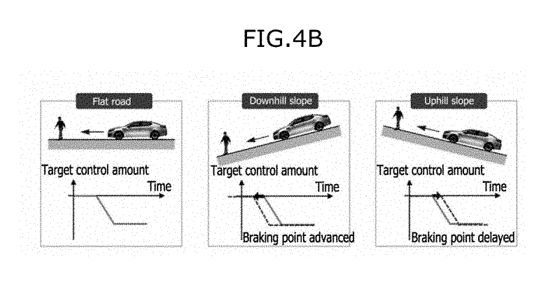

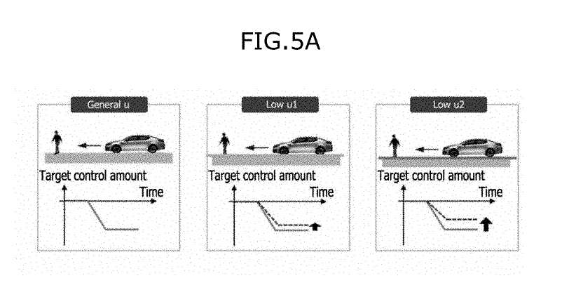

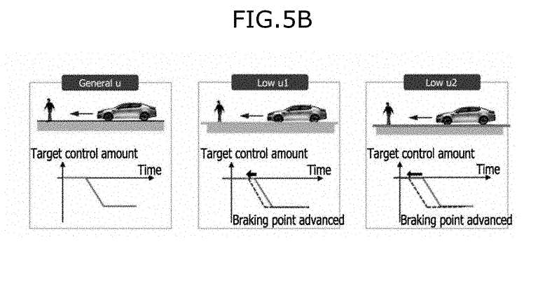

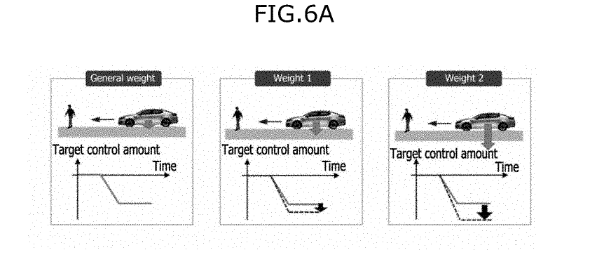

FIGS. 4A to 6B illustrate a difference between the existing FCA command and the compensated FCA command into which the condition of the road and the weight of the vehicle are reflected in FIG. 1.

FIG. 4A illustrates that the control unit 140 compensate for the target braking control amount of the FCA command by reflecting the road slope. When the road slope is a downhill slope, the control unit 140 may output the FCA command obtained by increasing the target control amount based on a target control amount (braking control amount) in a flat road illustrated in FIG. 4A. On the other hand, when the road slope is an uphill slop, the control unit 140 may output the FCA command obtained by decreasing the target control amount.

FIG. 4B illustrates that the control unit 140 compensates for the target braking point of the FCA command by reflecting the road slope. When the road slope is a downhill slope, the control unit 140 may output the FCA command obtained by advancing the target braking point based on a target braking point in a flat road illustrated in FIG. 4B. On the other hand, when the road slope is an uphill slop, the control unit 140 may output the FCA command obtained by delaying the target braking point.

Therefore, a difference in target stopping distance between the uphill slope and the downhill slope can be minimized while a sense of difference is reduced.

FIG. 5A illustrates that the control unit 140 compensates for the target braking control amount of the FCA command by reflecting the road friction coefficient. As the road friction coefficient becomes smaller than a general friction coefficient of FIG. 5A, for example, a reference friction coefficient (general u>Low u1>Low u2), the control unit 140 may output the FCA command obtained by further decreasing the target control amount based on a target control amount (braking control amount) at the general friction coefficient.

FIG. 5B illustrates that the control unit 140 compensates for the target braking point of the FCA command by reflecting the road friction coefficient. As the road friction coefficient becomes smaller than the general friction coefficient of FIG. 5A, for example, the reference friction coefficient (general u>Low u1>Low u2), the control unit 140 may output the FCA command obtained by further advancing the target braking point based on a target braking point at the general friction coefficient.

Therefore, while a slip of the vehicle is prevented, the braking distance can be increased to improve the stability.

FIG. 6A illustrates that the control unit 140 compensates for the target braking control amount of the FCA command by reflecting the vehicle weight. As the vehicle weight is increased, the control unit 140 may output the FCA command obtained by further increasing the target control amount based on a target control amount (braking control amount) at a general weight of FIG. 6A, for example, a reference weight.

FIG. 6B illustrates that the control unit 140 compensates for the target braking point of the FCA command by reflecting the vehicle weight. As the vehicle weight is increased, the control unit 140 may output the FCA command obtained by further advancing the target braking point based on a target braking point at the general weight of FIG. 6B, for example, the reference weight.

Therefore, a sense of difference can be reduced while a difference from the target stopping distance by the vehicle weight is minimized.

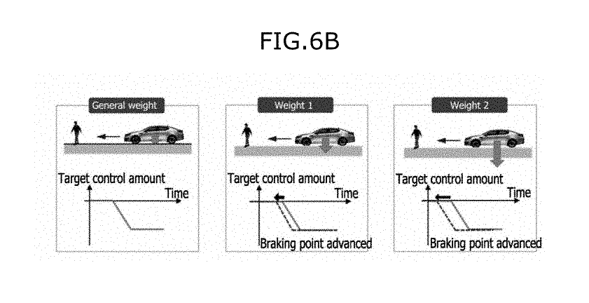

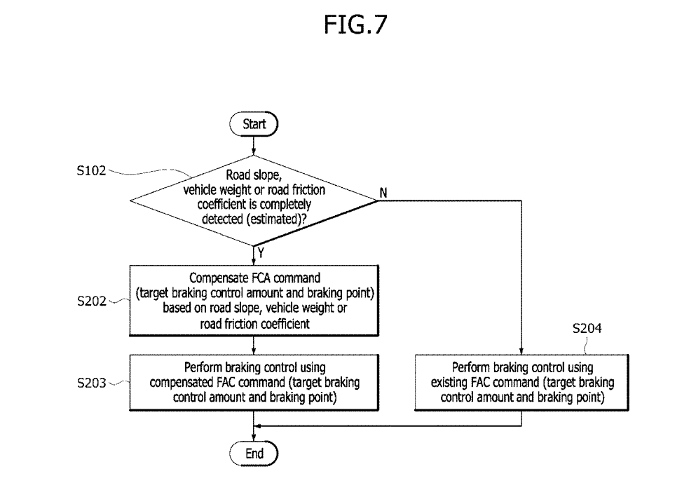

FIG. 7 is a flowchart illustrating a control method of an FCA system in accordance with an embodiment of the present invention.

As illustrated in FIG. 7, when one or more of a road slope, a vehicle weight and a road friction coefficient are completely detected or estimated (Y at step S201), the control unit 140 may calculate a compensation value by reflecting the detected or estimated one or more pieces of information (for example, the road slope, the vehicle weight and the road friction coefficient), and compensate the FCA command (i.e. the target braking control amount and braking point) at step S202.

Then, the control unit 140 may output the compensated FCA command (i.e. the command for the target braking control amount and braking point) to the brake operation unit 150 to perform braking control, at step S203.

However, when the one or more pieces of information (for example, the road slope, the vehicle weight and the road friction coefficient) for compensating the FCA command are not detected (N at step S201), the control unit 140 may output the FCA command (i.e. the target braking control amount and braking point) to the brake operation unit 150 to perform braking control, the FCA command being calculated based on the existing object information (i.e. relative distance and relative velocity), the ego vehicle velocity and the preset target stopping distance, at step S204.

In the present embodiments, the control apparatus and method of the FCA system can avoid a collision or reduce a collision speed by adjusting the AEB control amount and the braking point in consideration of the condition of the driving road and the weight of the vehicle, which makes it possible to prevent an accident or minimize accident damage.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A control apparatus of a Forward Collision-Avoidance Assist (“FCA”) system, comprising:
a vehicle weight detection unit configured to detect a weight of a vehicle;
a friction coefficient calculation unit configured to calculate a friction coefficient of a driving road;
a gradient calculation unit configured to calculate an acceleration correction value for a road slope as slope information of the road by reflecting actual acceleration information sensed through a wheel speed sensor into information sensed through an acceleration sensor; and
a control unit configured to calculate a compensation value by reflecting at least one of the slope of the road, the weight of the vehicle, and the friction coefficient of the road, and compensate an FCA command.

2. The control apparatus of claim 1, wherein the gradient calculation unit calculates a gradient based on a difference between an acceleration value sensed by the acceleration sensor and an actual acceleration value of the vehicle, as an acceleration difference caused by the slope of the road.

3. The control apparatus of claim 1, wherein the control unit outputs the compensated FCA command to a brake operation unit, and controls a target braking control amount and a target braking point.

4. The control apparatus of claim 1, wherein the control unit compensates the FCA command using the compensation value obtained by reflecting one or more of the slope of the road, the weight of the vehicle, and the friction coefficient of the road,
wherein the compensated FCA command is calculated by adding the compensation value (α(gsinθ)+β(M)+γ(μMg)) to the existing FCA command, where α, β, and γ represent weights for: the slope of the road, the weight of the vehicle, and the friction coefficient of the road, respectively.

5. The control apparatus of claim 3, wherein:
when the road slope is a downhill slope, the control unit outputs the FCA command obtained by increasing the target braking control amount based on a target braking control amount on a flat road and, when the road slope is an uphill slope, outputs the FCA command obtained by decreasing the target braking control amount; and
when the road slope is a downhill slope, the control unit outputs the FCA command obtained by advancing the target braking point based on a target braking point on the flat road, and, when the road slope is an uphill slope, outputs the FCA command obtained by delaying the target braking point.

6. The control apparatus of claim 3, wherein:
as the road friction coefficient becomes smaller than the general friction coefficient, the control unit outputs the FCA command obtained by decreasing the target braking control amount based on a target braking control amount at a general friction coefficient set to a reference friction coefficient; and
as the road friction coefficient becomes smaller than the general friction coefficient, the control unit outputs the FCA command obtained by advancing the target braking point based on a target braking point at the general friction coefficient.

7. The control apparatus of claim 3, wherein:
as the vehicle weight is increased, the control unit outputs the FCA command obtained by increasing the target braking control amount based on a target braking control amount at a general weight set to a reference weight; and
as the vehicle weight is increased, the control unit outputs the FCA command obtained by advancing the target braking point based on a target braking point at the general weight.

8. A control method of a Forward Collision-Avoidance Assist (“FCA”) system, comprising:
detecting the weight of a vehicle through a vehicle weight detection unit;
calculating the friction coefficient of a driving road through a friction coefficient calculation unit;
calculating, by a gradient calculation unit, an acceleration correction value for a road slope as slope information of the road by reflecting actual acceleration information sensed through a wheel speed sensor into information sensed through an acceleration sensor; and
calculating, by a control unit, a compensation value by reflecting at least one of: a slope of the road surface, a weight of the vehicle, and a friction coefficient of the road, and compensating an FCA command.

9. The control method of claim 8, wherein in order to calculate the slope information of the road, the gradient calculation unit calculates a gradient based on a difference between the acceleration value sensed by an acceleration sensor and the actual acceleration value of the vehicle, as an acceleration difference caused by the slope of the road.

10. The control method of claim 8, wherein after compensating the FCA command, the control unit outputs the compensated FCA command to a brake operation unit, and controls a target braking control amount and a target braking point.

11. The control method of claim 8, wherein:
in the compensating of the FCA command, the control unit compensates the FCA command using a compensation value obtained by reflecting at least one of the slope of the road, the weight of the vehicle, and the friction coefficient of the road; and
the compensated FCA command is calculated by adding the compensation value (α(gsinθ)+β(M)+γ(μMg)) to the existing FCA command, where α, β and γ represent weights for the slope of the road, the weight of the vehicle, and the friction coefficient of the road, respectively.

12. The control method of claim 10, wherein:
when the road slope is a downhill slope, the control unit outputs the FCA command obtained by increasing the target braking control amount based on a target braking control amount on a flat road, and when the road slope is an uphill slope, outputs the FCA command obtained by decreasing the target braking control amount; and
when the road slope is a downhill slope, the control unit outputs the FCA command obtained by advancing the target braking point based on a target braking point on the flat road, and when the road slope is an uphill slope, outputs the FCA command obtained by delaying the target braking point.

13. The control method of claim 10, wherein:
as the road friction coefficient becomes smaller than the general friction coefficient, the control unit outputs the FCA command obtained by decreasing the target braking control amount based on a target braking control amount at a general friction coefficient set to a reference friction coefficient; and
as the road friction coefficient becomes smaller than the general friction coefficient, the control unit outputs the FCA command obtained by advancing the target braking point based on a target braking point at the general friction coefficient.

14. The control method of claim 10, wherein:
as the vehicle weight is increased, the control unit outputs the FCA command obtained by increasing the target braking control amount based on a target braking control amount at a general weight set to a reference weight; and
as the vehicle weight is increased, the control unit outputs the FCA command obtained by advancing the target braking point based on a target braking point at the general weight.
